(19) United States
(12) Patent Application Publication
(10) Pub. No.: US 2025/0271183 A1
(43) Pub. Date: Aug. 28, 2025

(54) BATTERY POWERED HYBRID TRANSPORT REFRIGERATION UNIT

(71) Applicant: Ronald Koelsch, Roscommon, MI (US)

(72) Inventor: Ronald Koelsch, Roscommon, MI (US)

(21) Appl. No.: 19/207,531

(22) Filed: May 14, 2025

Related U.S. Application Data
(63) Continuation-in-part of application No. 17/822,449, filed on Aug. 26, 2022.
Application No. 17/822,449 is a continuation-in-part of application No. 15/902,588, filed on Feb. 22, 2018, now abandoned.
(60) Provisional application No. 62/462,966, filed on Feb. 24, 2017.

(51) Int. Cl. F25B 27/00; F25D 11/00

(52) U.S. Cl. CPC F25B 27/002; F25D 11/003

(57) ABSTRACT

Battery powered hybrid reefers that use for their driving force, energy derived from the best-mix integrated combination of electrical power generated from an internal combustion engine generator, an electric grid, a wheel driven generator and at least one solar panel.

### CROSS-REFERENCE TO RELATED APPLICATIONS

This application is a Continuation-in-part application of Utility patent application Ser. No. 17/822,449, filed Aug. 26, 2022 which is a Utility patent application Ser. No. 15/902,588, filed Feb. 22, 2018, from which priority is claimed.

### STATEMENT REGARDING FEDERALLY SPONSORED RESEARCH OR DEVELOPMENT

### Not Applicable.

### REFERENCE TO SEQUENCE LISTING, A TABLE, OR A COMPUTER PROGRAM LISTING COMPACT DISC APPENDIX

Not Applicable.

### BACKGROUND OF THE INVENTION

The present invention relates to powering transport refrigeration units (TRUS) commonly called reefers. These reefers are used for transport of temperature sensitive cargo such as food.

A reefer can be a semi-trailer with an integral refrigeration unit, or a container used for intermodal transport. Intermodal refrigerated containers are used to transport freight using different modes of transport from ship to rail to truck. They eliminate the need for unloading and reloading.

Prior art reefers are driven by electric motors or internal combustion engines, usually diesels. Some use a combination of diesel engines and electric motors.

When these reefers are stationary and in electric mode of operation, the electric motor is plugged directly into the high-voltage AC electrical grid. For purposes of this invention, “high voltage” means 208 to 480 AC and “low Voltage” means 36 to 60. It typically runs on 480 volt 3-phase power. The utility of these reefers is offset by safety limitations and environmental pollution.

When mobile, these reefers run exclusively on diesel power, producing noise and chemical pollution. When stationary during loading and staging they are supposed to run on electric grid power. This requires over 2,000 plug-in operations per year for each reefer. Workers moving the reefers for loading often neglect to plug them into the electric grid so they continuously run on diesel.

The diesel exhaust of a semi-trailer reefer produces upwards of 50 tons of greenhouse gas annually along with localized poisonous black carbon. Some personnel are reluctant to plug and un-plug these electric/diesel reefers because they fear handling 480 volts. Moving semi-trailers in warehouse yards can result in damage to electrical infrastructure and subsequent electrification of the reefer chassis.

The advent of battery powered TRUs, described in U.S. Pat. No. 8,935,933 opened the door for flexibility in power source methodology. Electrical energy derived from the grid, a wheel driven generator, described in U.S. Pat. No. 9,415,660, or a solar panel, is stored in the battery. The battery then becomes the single source of low-voltage-dc power for the electric motor that eliminates the diesel engine and the refrigeration compressor and the air distribution system of the reefer refrigeration unit.

These prior art battery powered TRUs have limited range because the run time is determined by battery capacity, motion to drive the wheel generator and sunlight for solar panel power. For instance, solar can be used exclusively in the southwest USA, but operation in cloudy climates requires a supplemental power source.

Prior art reefers use remote evaporators in the rear chambers of multi-chamber units. These remote evaporators draw refrigerant from the freezer chamber evaporator whenever they run. This degrades freezer performance and causes the refrigeration unit to run excessively.

The instant invention is a battery powered hybrid reefer that uses for its driving force, energy derived from the best-mix integrated combination of electrical power from an internal combustion engine generator, the electric grid, a wheel driven generator and a solar panel.

The small on-board The internal combustion engine (ice) generator is a supplemental power source. It runs and produces power only when other power sources are not sufficient to keep the battery charged, thus minimizing the use of fossil fuel.

Refrigeration efficiency is improved by eliminating remote evaporators. Freezer air, rather than refrigerant, is transferred to refrigerator chambers. The refrigeration unit consumes less energy, and the reefer range is further extended.

These solar panel equipped battery powered hybrid reefers, when stationary, are networked into an electric power generating plant forming a low voltage dc micro-grid. Excess energy not used by the reefers is stored in a high-capacity central battery such as a land-based flow battery.

### BRIEF SUMMARY OF THE INVENTION

There is disclosed herein, in one embodiment, a battery powered hybrid reefer having multiple integrated power sources. The battery powered hybrid refrigerated reefer comprises a hybrid refrigerated reefer; an on-board battery that powers all systems of said hybrid refrigerated reefer including the electric motor that drives the refrigeration compressor and the air distribution fans; a computerized control system having sensors for battery status of charge, solar panel output, reefer motion, grid usage, and fuel level. These components are used by the computer in combination, to optimize the mix of power sources in order to minimize emissions and cost for any given reefer application.

In another embodiment, there is in combination a land-based auxiliary power unit (apu) that plugs into the reefer when it is stationary. A land-based auxiliary power unit can be, for purposes of this invention, an electrical grid, a stationary electrical power unit, or can be a semi-truck auxiliary power unit manufactured by, for example, Thermo King. This apu takes high-voltage ac power from the electric grid or a Thermo King and converts it to safe low voltage dc power to be plugged into the reefer to charge the battery and power the refrigeration unit.

Only low-voltage direct current (dc) power is used on the reefer. Mechanics and yard personnel never handle 480 volt 3-phase ac power. The risk of high voltage shock is completely avoided, thus solving the high voltage safety problems of the above-mentioned prior art.

In yet another embodiment of this invention there is in combination, an apu mounted on the reefer so its battery can be charged from the electrical grid when in remote locations.

Further still, there is in combination embodiment of this invention which is a mobile auxiliary power unit mounted on a semi-tractor connected to the refrigerated reefer, for charging the reefer battery and running the refrigeration unit.

In still another embodiment in this invention, there is an air handling system that improves the efficiency of the refrigeration unit of the hybrid reefer by eliminating remote evaporators. Cold air is extracted from the freezer chamber and delivered to the refrigerator chambers so remote evaporators in the refrigerator chambers are not needed. Therefore, refrigerant is never taken from the freezer evaporator, and it always operates at peak performance. Critical freezer temperatures are easily maintained. The degradation of freezer performance associated with the transfer of refrigerant from the freezer evaporator to remote evaporators, along with using hot gas to defrost remote evaporators, makes the diesel reefer run twice as much as the hybrid reefer of this invention.

The further embodiment is the direct current micro grid combination. Multiple battery powered hybrid reefers with solar panels are commonly connected in a charge control network. When a reefer battery needs charging it draws charge from not only its own solar panel, but also those of the more fully charged reefers. In addition, a land-based auxiliary solar panel and central storage battery are a common energy source. The fleet of battery powered hybrid reefers with solar panels becomes a local electric power generation plant. This low voltage direct current-micro-grid allows the fleet to operate independent of the power company high voltage ac electric grid commonly called shore power.

Also contemplated within the scope of this invention is a semi-trailer hybrid refrigerated reefer system with a transport refrigeration unit powered exclusively by a battery of sixty volts direct current or less comprising a cooling system having a transport refrigeration unit cooling power of at least 18 kW at 35° F. The reefer system has a power draw from a battery of 8 kW or less, the reefer system has a coefficient of performance of 2.25 or greater, and no greater than 60 V direct current voltage throughout the reefer system.

Any power generator sources that are utilized are connected directly and in parallel to the battery to independently or in combination, to charge the battery anytime it is less than 100% state of charge, and any power generating source is making power. The power generating source for the battery charging is certified as zero emissions by the California Air Resources Board, and has integral 1 cooling chambers at walls, floor, and ceiling of the reefer.

Further contemplated within the scope of this invention is a combination of a land-based auxiliary power unit that converts high voltage alternating current to safe low voltage direct current for charging the reefer battery and powering the reefer refrigeration, and a land-based high voltage alternating current electrical grid.

Still further contemplated within the scope of this invention is a combination of a mobile auxiliary power unit mounted on a reefer for charging a battery, and a land-based electrical grid. In addition, there is a battery powered hybrid refrigerated reefer wherein there is a mobile auxiliary power unit mounted on a semi-tractor connected to the refrigerated reefer.

There is a combination contemplated in this invention in which there is a battery powered hybrid refrigerated reefer and an internal combustion engine generator mounted onboard the reefer.

There is a combination contemplated in this invention in which there is a battery powered hybrid refrigerated reefer and an internal combustion engine generator mounted onboard a semi-tractor connected to the refrigerated reefer.

Further contemplated within the scope of this invention is a battery powered hybrid-refrigerated reefer wherein there is an integrated power source which is an electrical grid/shore power plug-in.

There is a separate combination in this invention which is a battery powered hybrid refrigerated reefer as defined herein wherein the integrated power source is a wheel generator mounted on said reefer.

There is another separate combination in this invention which is a battery powered hybrid refrigerated reefer as defined herein and an integrated power source which is a solar panel mounted on the reefer.

Finally, there is yet another separate combination of at least two battery powered hybrid refrigerated reefers wherein the reefers are connected in common to a charge control unit with an auxiliary land-based solar panel and central storage battery.

### BRIEF DESCRIPTION OF THE SEVERAL VIEWS OF THE DRAWING(S)

FIG. 1 is a view in perspective of a semi-trailer reefer of this invention showing the semi-trailer battery powered hybrid reefer with all four-power sources.

FIG. 2 is a view in perspective of the front of a refrigeration unit for a reefer of this invention.

FIG. 3 is a view from the lower rear inside showing an air handling system for a reefer of this invention.

FIG. 4 is a view in perspective of the intermodal container battery powered hybrid reefer of this invention with three separate power sources.

FIG. 5 is a schematic of the computer system that designates the power sources for this invention.

FIG. 6 is a schematic layout of the low voltage dc-micro-grid useful in this invention.

### DETAILED DESCRIPTION OF THE INVENTION AND DRAWINGS

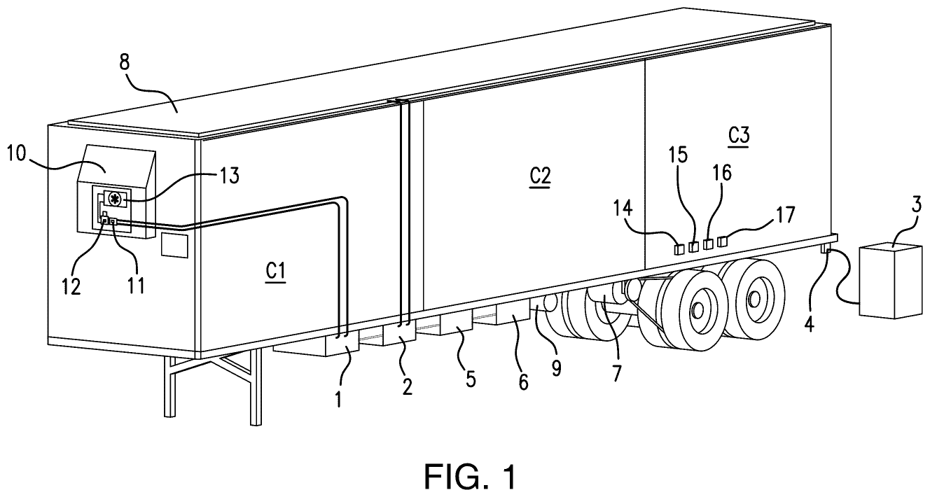

Turning now to FIG. 1, there is shown a view in perspective of a semi-trailer battery powered hybrid reefer with all four-power sources.

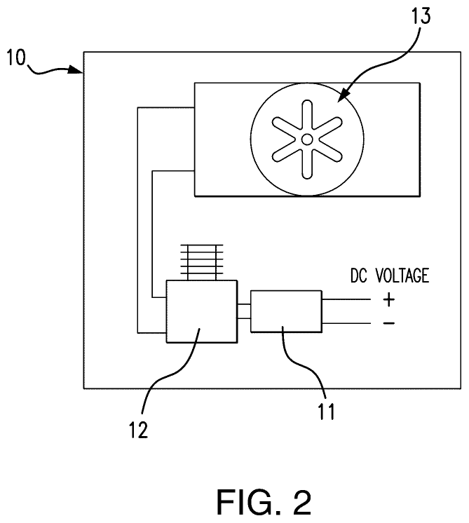

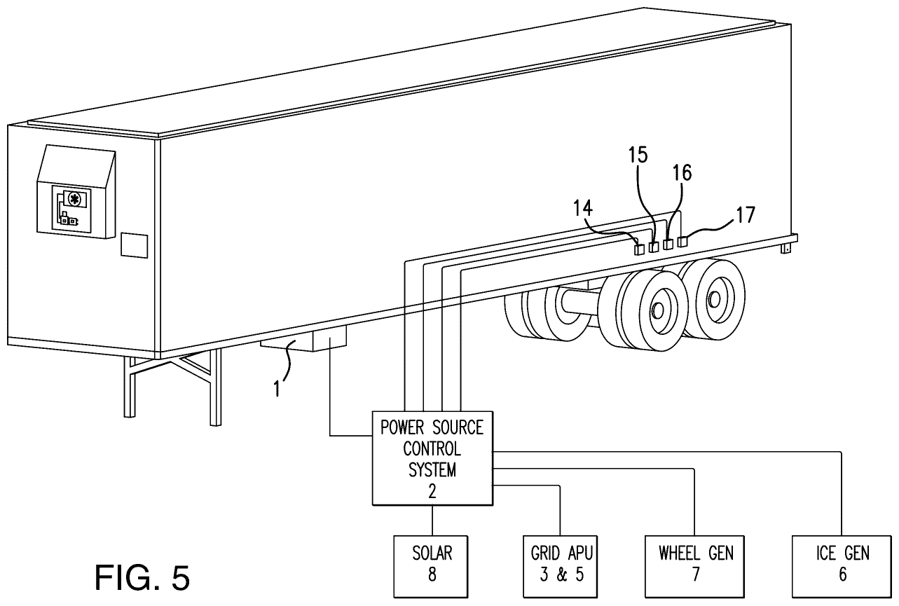

A battery (1) powers the entire refrigeration system (10) including the electric motor (11) that drives the refrigeration compressor (12) and the air distribution fans (13) shown in FIG. 2. It is tied directly to the power-source control system (2) of FIG. 5 that manages power sourcing.

Electric grid power charges the battery (1) by powering a land-based auxiliary power unit (apu) (3). The apu converts the high voltage ac-grid power to low voltage dc-output power that can be safely plugged into the trailer socket (4). It operates as a battery charger when the refrigeration unit (10) is off and as a power source when it is on. The onboard apu (5) plugs directly into lower voltage grid power at remote locations, sometimes called shore power. These integral power generator sources are utilized and connected directly, and in parallel, to the battery to independently or in combination, charge the battery.

Thousands of plug-in cycles are performed monthly in a typical fleet operation. It is vital to avoid electrocution hazards associated with workers handling 480 volts. The apu configuration of this invention converts this high voltage (208 to 480 ac) to low voltage (36 to 60 dc) so all plug-in cycles involve only safe low voltage dc power.

An internal combustion engine generator (6), wheel generator (7) and solar panel (8) charge the battery (1) through the power-source control system (2). A tank or bottle (9) supplies fuel for the internal combustion engine of the generator (6).

In somewhat more detail, the internal combustion engine (ice) generator (6) is shown mounted on a semi-trailer battery powered hybrid reefer in FIG. 1. Its fuel can be any variety of fossil fuels such as diesel, gasoline, propane, liquid natural gas, etc. or a fuel cell, such as a hydrogen fuel cell. The engine can be a small turbine or rotary type engine.

The ice generator can be mounted on the semi-tractor pulling the trailer (not shown). However, the advantage of mounting it on board the semi-trailer is that the semi-trailer reefer is then self-contained, and any tractor configuration can be used to pull the battery powered hybrid reefer. The ice generator is used according to the specific reefer application.

Applications that require minimum emissions use solar panels (8) as the primary power source. This also applies when this hybrid battery powered reefer is located in very remote inaccessible areas. Regions with less prevalent solar exposure depend more on the grid-powered APU (3) for primary stationary power. These regions use this hybrid reefer configured with the ice generator (6) as a supplemental energy source especially for applications that have long refrigeration times before unloading. The ice generator extends battery lifetime.

The engine driving this onboard ice generator (6) is much smaller, quieter, cleaner running and more efficient than the large diesel engine used to power traditional reefer refrigeration units. Traditional reefers demand a lot of torque and power to drive the refrigeration compressor because of the start/stop nature of their operation. Consequently, they must use large (18Kw) diesel engines as in the prior art.

The battery-powered dc electric motor (11) that eliminates these large inefficient diesel engines easily accommodates this high startup torque using less power (8Kw) because it produces high torque at low rpm. The small onboard ice generator (6) producing only 4Kw of power easily provides enough energy to drive the refrigeration unit. The refrigeration unit (10) of this battery powered hybrid reefer only runs 30% of the time to maintain temperature, consuming just 2.4 Kwh of energy in one hour. The ice generator (6) when run in a more efficient steady state mode produces 4 Kwh of electric energy in one hour since its power output is continuously stored in the battery (1). It makes enough energy to solely run the reefer. Its operation must be integrated into the overall power system.

A computerized power-source control system (2) is used to optimize the mix of power sources. Some refrigerated cargo deliveries are of a short duration and demand minimum emissions. The control system (2) then configures this battery powered hybrid reefer for an all-solar power usage scenario and completely avoids the use of fossil fuels except in emergencies where the refrigerated cargo could be irretrievably spoiled. The ice generator (6) can always be engaged in an emergency.

The power-source control system (2) automatically configures power source usage to minimize fossil fuel consumption and emissions. Solar power is prioritized for first usage followed by the grid powered auxiliary power units (3) and (5), wheel generator (7) and ice generator (6) in that order. Sensing battery state of charge, solar panel output, grid usage and reefer motion determine the engagement of the wheel generator (7) and the ice generator (6). Onboard fossil fuel is not burned when grid power is being used or when there is enough motion to use the wheel generator (7). The ice generator (6) is only used when the solar panel (8), wheel generator (7) and grid powered APU (3) and (5) cannot provide sufficient energy.

A transport scenario that takes more time and distance may not be feasible with just solar and grid power sources because the real time electrical energy requirement may exceed the battery capacity and the solar and grid power generation capability. The control system (2) anticipates this and configures the moving hybrid reefer accordingly, to initially run only on solar power to conserve fuel and then engage other power sources.

When the control system (2) engages the wheel generator (7) there is a small increase in fossil fuel consumption and emissions due to the additional drag placed on the semi-tractor pulling the reefer. Even so, the wheel generator only uses one gallon of diesel fuel from the tractor to run the refrigeration unit for 6 hours.

If the control system senses trailer motion that is not sufficient for the wheel generator (7) to keep the battery (1) charged, or, the reefer is stationary, the ice generator (6) engages to charge the battery (1) and supplement the solar panel power. An array of sensors provides operational status to the control system (2) computer. Separately they are a battery state-of-charge meter (14), fuel gauge (15), trailer motion sensor (16) and amperage meter (17) for the solar panel output (8), apu (3) and (5) and wheel generator (7). The control system (2) computer uses its data to prioritize the energy source configuration.

Solar energy consumption has priority to minimizing fossil fuel usage, while still performing long duration refrigerated cargo transport missions. The long duration capability of this battery powered hybrid reefer is a big advantage over the limited duration of previous electric reefers. This semi-trailer battery powered hybrid reefer can now be used for so called “drop and hook” deliveries where one refrigerated cargo is delivered and another is loaded for a separate delivery, even when grid power is not available.

Refrigeration efficiency is a key ingredient of the hybrid battery powered TRU's feasibility. Combining the low power consumption of the electric motor (11) driven compressor (12) with the transfer of cold freezer chamber (C1) air to refrigerator chambers (C2) and (C3) improves the refrigeration unit (10) coefficient of performance (COP), power-in versus cooling power-out.

Traditional diesel reefers have a COP of less than 1.0 while this battery powered hybrid reefer has a COP of 3.0. The diesel uses 9 Kwh of energy while this hybrid only uses 2.4 Kwh. The difference is partly due to electric power versus diesel power, but the superior air handling of this invention means the hybrid electric runs half the time as a diesel with remote evaporators.

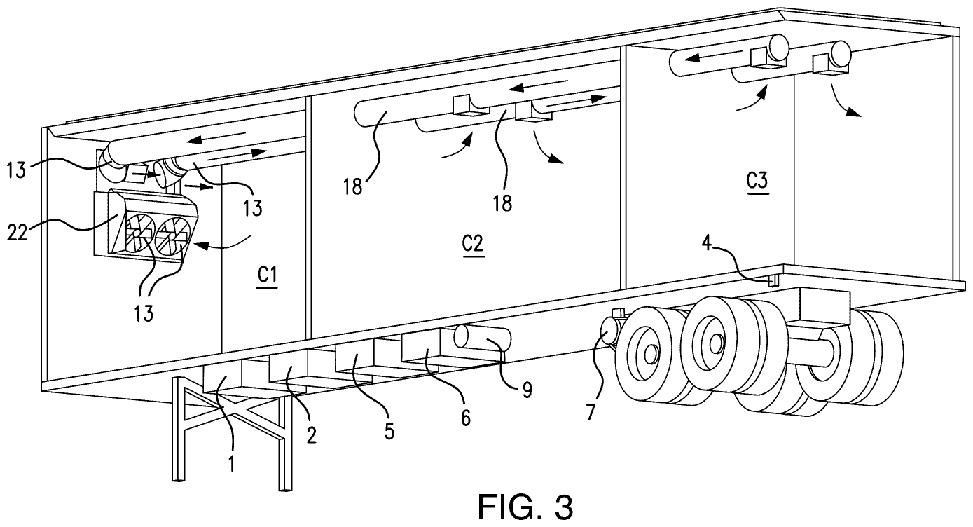

Freezer air is mixed in the mixing chamber (22) with warmer air drawn from the refrigerators (C2) and (C3) as shown in FIG. 3. This mixed cool air is extracted from the post freezer evaporator side of the freezer chamber (C1) and transferred via fans (13) and ducts (18) to the refrigerator chambers (C2) and (C3) to maintain their temperatures as shown in FIG. 3. Remote evaporators previously used in prior art refrigerator chambers are eliminated. Refrigerant is never taken from the freezer evaporator as it is with remote evaporators. The freezer always operates at peak performance and the refrigeration unit (10) run time is minimized.

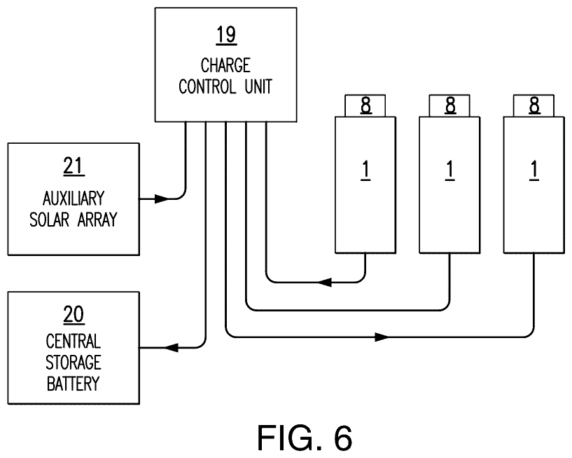

A fleet of battery powered hybrid reefers is shown plugged together in a low voltage dc-micro-grid in FIG. 6. Three reefers equipped with a solar panel (8) and battery (1) are hooked together in a common charging network. When a low state-of-charge battery needs charging, the central charge control unit (19) allows it to draw charge from not only its own solar panel but also that of the more fully charged reefers. Charge control units can be those manufactured by Bosch Mobility Solutions. In addition, there is an auxiliary central battery (20) and a land-based solar panel (21) that provides enough solar generated electric energy to run the fleet independent of the high voltage ac power company grid.

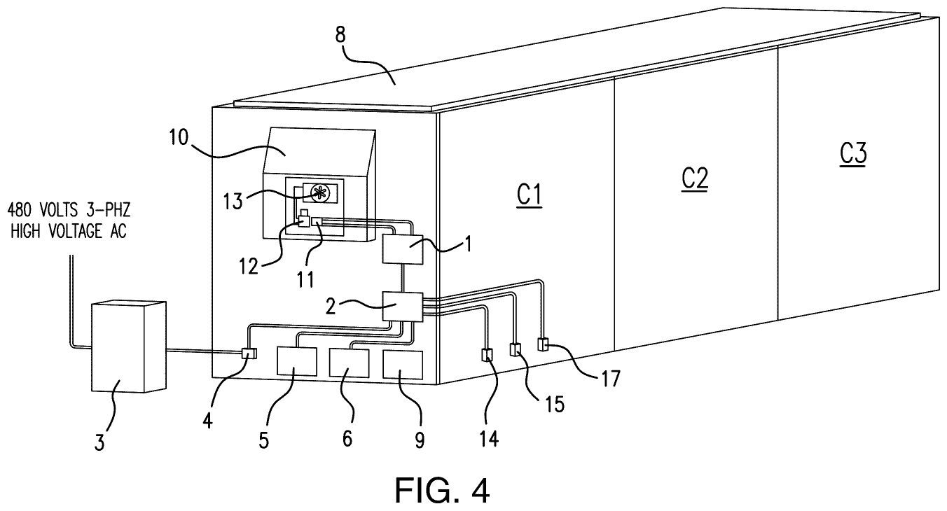

Turning to FIG. 4, there is shown a view in perspective of the intermodal container battery powered hybrid reefer with three-power sources. It operates just like the above-described semi-trailer hybrid reefer, except for the wheel generator (7).

Thus, there is shown in FIG. 4 a battery (1) that powers the entire refrigeration system (10) and is tied directly to a power-source control system (2). Electric grid power charges the battery (1) through a land-based APU (3) with its output plugged into the container socket (4). An onboard APU (5) plugs directly into the grid. An internal combustion engine generator (6) and solar panel (8) charge the battery (1) through the power control system (2). A tank (9) supplies fuel for the internal combustion engine of the ice generator (6).

Like the semi-trailer hybrid reefer, the low voltage dc-micro-grid shown in FIG. 6 with a charge control unit (19), a central battery (20) and a land based auxiliary solar panel (21) provides enough solar generated electric energy to run multiple containers independent of the high voltage ac power company grid.

This battery powered hybrid reefer makes best use of renewable-clean energy. Unlike the all-electric battery powered reefer, it has the performance and flexibility to meet all refrigerated cargo transport applications. Storing energy by battery allows a simple hybrid system that is cost effective and commercially viable.

What is claimed is:

1. A battery powered hybrid refrigerated reefer having multiple integrated power sources, said battery powered hybrid refrigerated reefer comprising:
A. a hybrid refrigerated reefer;
B. an on-board battery that powers said hybrid reefer, an electric motor, and air distribution fans;
C. a control system containing sensors for
i. a battery charge status,
ii. solar panel output,
iii. reefer motion,
iv. grid usage, and,
v. fuel level, such that A., B., and C.,
in combination, configure the optimum power source combination to minimize fossil fuel consumption in the use of said reefer;
D. an air distribution system comprising:
an air mixing chamber,
airflow ducting, and,
air distribution fans.

2. In combination:
a. A land-based auxiliary power unit that converts high voltage alternating current to safe low voltage direct current for charging said reefer battery and powering said reefer refrigeration as claimed in claim 1 and,
b. a land-based high voltage alternating current electrical grid.

3. In combination:
a. a mobile auxiliary power unit mounted on a reefer for charging a battery, and,
b. a land-based electrical grid.

4. The battery powered hybrid refrigerated reefer as claimed in claim 1 wherein, in addition, there is a mobile auxiliary power unit mounted on a semi-tractor connected to said refrigerated reefer.

5. The battery powered hybrid refrigerated reefer as claimed in claim 1 wherein, in addition, there is an internal combustion engine generator mounted onboard said reefer.

6. The battery powered hybrid refrigerated reefer as claimed in claim 1 wherein, in addition, there is an internal combustion engine generator mounted onboard a semi-tractor connected to said refrigerated reefer.

7. The battery powered hybrid-refrigerated reefer as claimed in claim 1 wherein said integrated power source is an electrical grid/shore power plug-in.

8. The battery powered hybrid refrigerated reefer as claimed in claim 1 wherein said integrated power source is a wheel generator mounted on said reefer.

9. The battery powered hybrid refrigerated reefer as claimed in claim 1 wherein said integrated power source is a solar panel mounted on said reefer.

10. In combination, at least two battery powered hybrid refrigerated reefers as claimed in claim 1 wherein said reefers are connected in common to a charge control unit with an auxiliary land-based solar panel and central storage battery.

11. A semi-trailer hybrid refrigerated reefer system with a transport refrigeration unit powered exclusively by a battery of sixty volts direct current or less comprising:
i. a cooling system having said transport refrigeration unit cooling power of at least 18 kW at 35° F.;
ii. said reefer system having a power draw from said battery of 8 kW or less, said reefer system having a coefficient of performance of 2.25 or greater, and no greater than 60 V direct current voltage throughout said reefer system;
iii. wherein at least one integral power generator sources that are utilized and connected directly, and in parallel, to said battery to independently or in combination, charge the battery anytime the charge is less than 100% and said at least one power generator source is making power;
iv. said any power generating source for said battery charging is certified as zero emissions, and
v. integral cooling chambers at the walls, floor and ceiling of said reefer.

12. In combination:
a. A land-based auxiliary power unit that converts high voltage alternating current to safe low voltage direct current for charging said reefer battery and powering said reefer refrigeration as claimed in claim 11 and,
b. a land-based high voltage alternating current electrical grid.

13. In combination:
a. a mobile auxiliary power unit mounted on a reefer for charging a battery, and,
b. a land-based electrical grid.

14. The battery powered hybrid refrigerated reefer as claimed in claim 11 wherein, in addition, there is a mobile auxiliary power unit mounted on a semi-tractor connected to said refrigerated reefer.

15. The battery powered hybrid refrigerated reefer as claimed in claim 11 wherein, in addition, there is an internal combustion engine generator mounted onboard said reefer.

16. The battery powered hybrid refrigerated reefer as claimed in claim 11 wherein, in addition, there is an internal combustion engine generator mounted onboard a semi-tractor connected to said refrigerated reefer.

17. The battery powered hybrid-refrigerated reefer as claimed in claim 11 wherein said integrated power source is an electrical grid/shore power plug-in.

18. The battery powered hybrid refrigerated reefer as claimed in claim 11 wherein said integrated power source is a wheel generator mounted on said reefer.

19. The battery powered hybrid refrigerated reefer as claimed in claim 11 wherein said integrated power source is a solar panel mounted on said reefer.

20. In combination, at least two battery powered hybrid refrigerated reefers as claimed in claim 11 wherein said reefers are connected in common to a charge control unit with an auxiliary land-based solar panel and central storage battery.

21. A battery powered hybrid refrigerated reefer having multiple integrated power sources, said battery powered hybrid refrigerated reefer comprising:
A) a hybrid refrigerated reefer;
B) an on-board battery that directly powers the electric motor that drives a refrigeration compressor and fans of the said powered hybrid refrigerated reefer using only Direct Current power;
C) an on-board hydrogen generator fuel cell that charges said battery;
D) a control system containing sensors for
i) said battery charge status,
ii) a solar panel output,
iv) grid usage, and,
v) fuel level, such that A), B), and C) in combination configure the optimum integrated power source combination to minimize fossil fuel consumption in the use of said reefer.

22. In combination:
a) a land-based auxiliary power unit that converts higher voltage alternating current to lower voltage direct current for charging said battery as claimed in claim 21 and,
b) a land-based solar powered electrical grid for charging said battery.

23. The battery powered hybrid refrigerated reefer as claimed in claim 21 wherein, in addition, there is an internal combustion engine generator mounted on-board said reefer.

24. The battery powered hybrid refrigerated reefer as claimed in claim 21 wherein, in addition, there is a fuel cell generator mounted on-board said refrigerated reefer.

25. The battery powered hybrid refrigerated reefer as claimed in claim 21 wherein said integrated power source is an electrical gird/shore power plug-in.

26. The battery powered hybrid refrigerated reefer as claimed in claim 21 wherein said integrated power source is a wheel generator mounted on the underside of said reefer.

27. The battery powered hybrid refrigerated reefer as claimed in claim 21 wherein said integrated power source is a solar panel mounted on said reefer.

28. In combination, at least two battery powered hybrid refrigerated reefers as claimed in claim 21 wherein said reefers are connected in common to a charge-control unit with a land-based solar panel array and central storage battery.
